(19) United States
(12) Patent Application Publication
(10) Pub. No.: US 2015/0028562 A1
(43) Pub. Date: Jan. 29, 2015

(54) Accessory Exchange System For Trailers

(71) Applicant: Excel Plastics, LLC, Fergus Falls, MN (US)

(72) Inventor: Curtis J. Hill, Warba, MN (US)

(73) Assignee: Excel Plastics, LLC, Fergus Falls, MN (US)

(21) Appl. No.: 13/952,148

(22) Filed: Jul. 26, 2013

(51) Int. Cl. B62D 63/08

(52) U.S. Cl. CPC B62D 63/08
USPC 280/400

(57) ABSTRACT

An accessory exchange system for trailers for that provides for various interchangeable accessories to be attached to the trailer. The accessory exchange system for trailers generally includes a mounting bracket for mounting to the frame of a trailer, a base coupler extending from the mounting bracket, a support arm removably connected to the base coupler, and an accessory device removably connected to the support arm.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to accessories for trailers and more specifically it relates to an accessory exchange system for trailers that provides for various interchangeable accessories to be attached to the trailer.

2. Description of the Related Art

Any discussion of the related art throughout the specification should in no way be considered as an admission that such related art is widely known or forms part of common general knowledge in the field.

Accessories for trailers (e.g. boat trailers, utility trailers) have been in use for years. Common types of accessories for boat trailers include gas container storage devices that are attached to the trailer tongue with fasteners or brackets. While conventional accessories for boat trailers are suitable for their intended purpose, they are limited to only one type of accessory and cannot be interchanged with other accessories.

Because of the inherent problems with the related art, there is a need for a new and improved accessory exchange system for trailers that provides for various interchangeable accessories to be attached to the trailer.

### BRIEF SUMMARY OF THE INVENTION

The invention generally relates to accessories for trailers which includes a mounting bracket for mounting to the frame of a trailer, a base coupler extending from the mounting bracket, a support arm removably connected to the base coupler, and an accessory device removably connected to the support arm.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention attached to a boat trailer.

FIG. 2 is an exploded upper perspective view of the present invention with respect to the trailer tongue of a trailer.

FIG. 3 is an exploded upper perspective view of the present invention with a pair of bucket holders.

FIG. 4 is a front view of the present invention attached to a trailer tongue.

FIG. 5 is a top view of the present invention attached to a trailer tongue.

FIG. 6 is a top view of the present invention illustrating the different positions the accessory device can be rotated.

FIG. 7 is an upper perspective view of the present invention with a table in an exploded position.

FIG. 8 is an upper perspective view of the present invention with the table attached.

FIG. 9 is an upper perspective view of the present invention with the accessory device comprised of a storage unit.

FIG. 10 is an upper perspective view of the present invention with a cap member attached instead of an accessory device and with a tire support extending to the side thereof.

FIG. 11 is an upper perspective view of the present invention attached to a utility trailer.

FIG. 12 is an upper perspective view of the present invention attached to a side frame member of a boat trailer with the accessory device comprised of a table.

FIG. 13 is an upper perspective view of an alternative embodiment wherein the support arm is comprised of an adjustable arm having a pivot joint.

FIG. 14 is an exploded upper perspective view of the alternative embodiment.

FIG. 15 an upper perspective view of the present invention attached to a side frame member of a boat trailer with the accessory device comprised of a bucket holder.

FIG. 16 an exploded upper perspective view of the present invention attached to the side frame member with the accessory device comprised of the bucket holder.

FIG. 17 is an upper perspective view of the present invention with the bucket holder and a pair of buckets in an exploded position.

FIG. 18 is an upper perspective view of the present invention attached to the side frame member with a cap member and the tire holder.

FIG. 19 is an upper perspective view of the present invention with a vertical arm extending upwardly from an extended arm with a storage unit removably connected to the vertical arm.

FIG. 20 is an upper perspective view of the present invention illustrating the support member that is attached to a storage unit directly connected to the tubular coupler.

FIG. 21 is an upper perspective view of the present invention illustrating the base coupler directly and non-removably attached to the side frame member.

FIG. 22 is an upper perspective view of the present invention illustrating a seat attached to the tongue for a user to sit upon while using the table.

### DETAILED DESCRIPTION OF THE INVENTION

### A. Overview

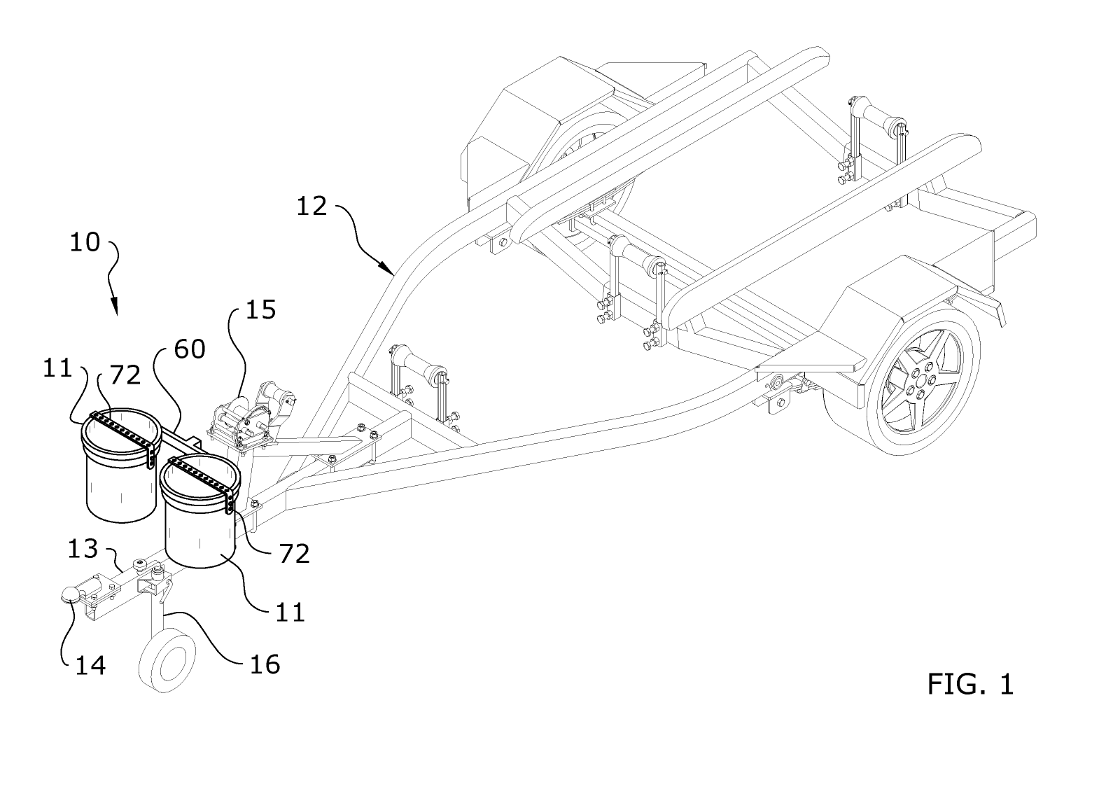

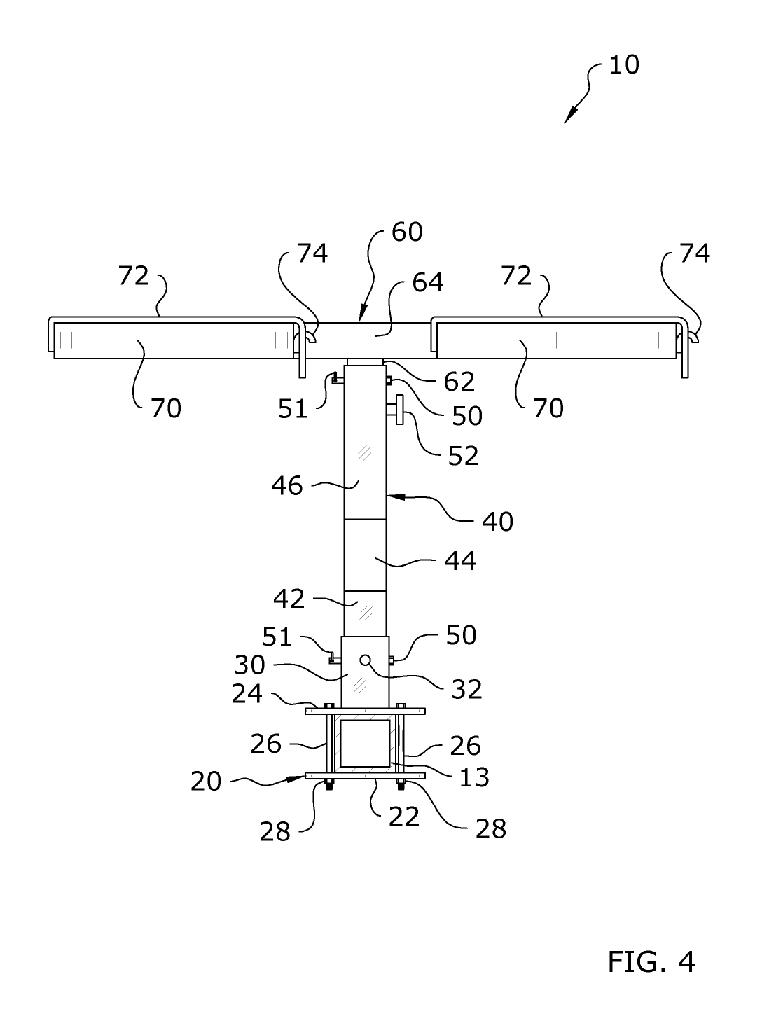

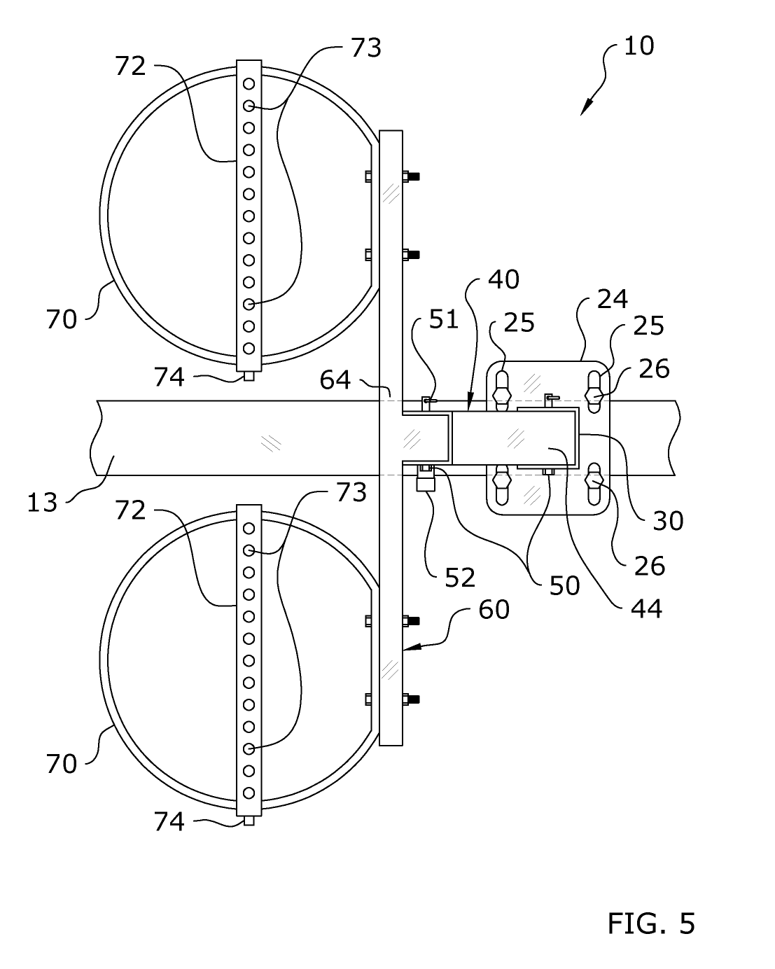

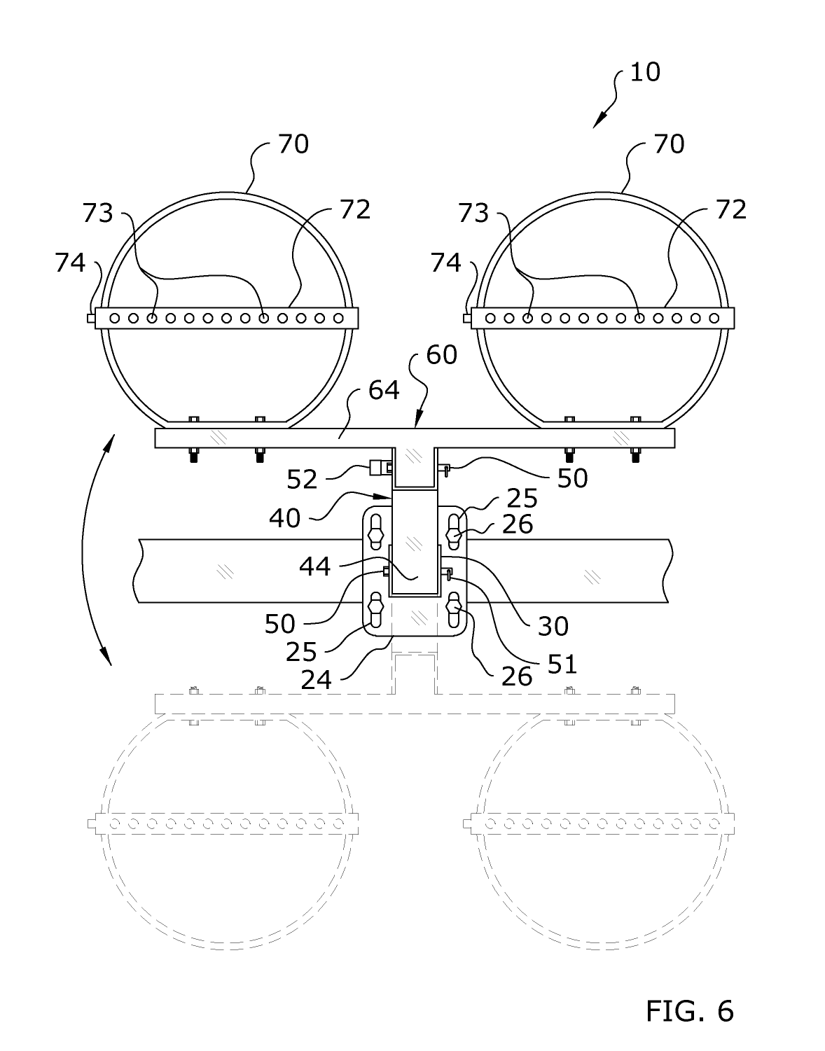

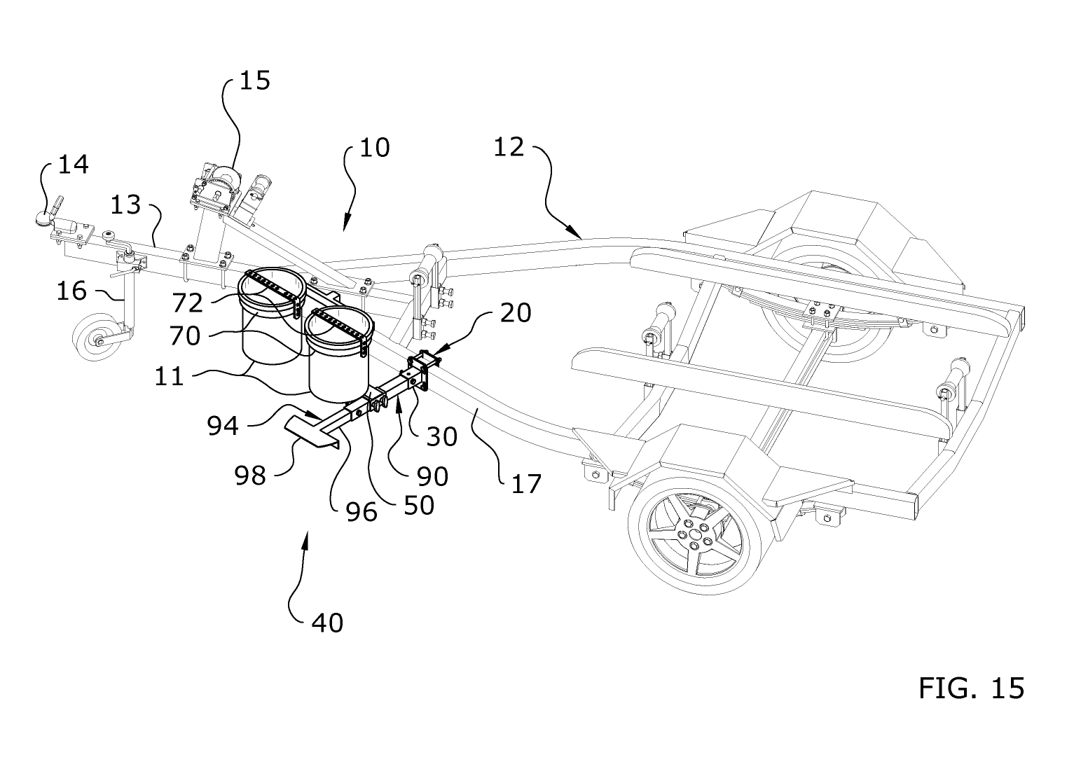

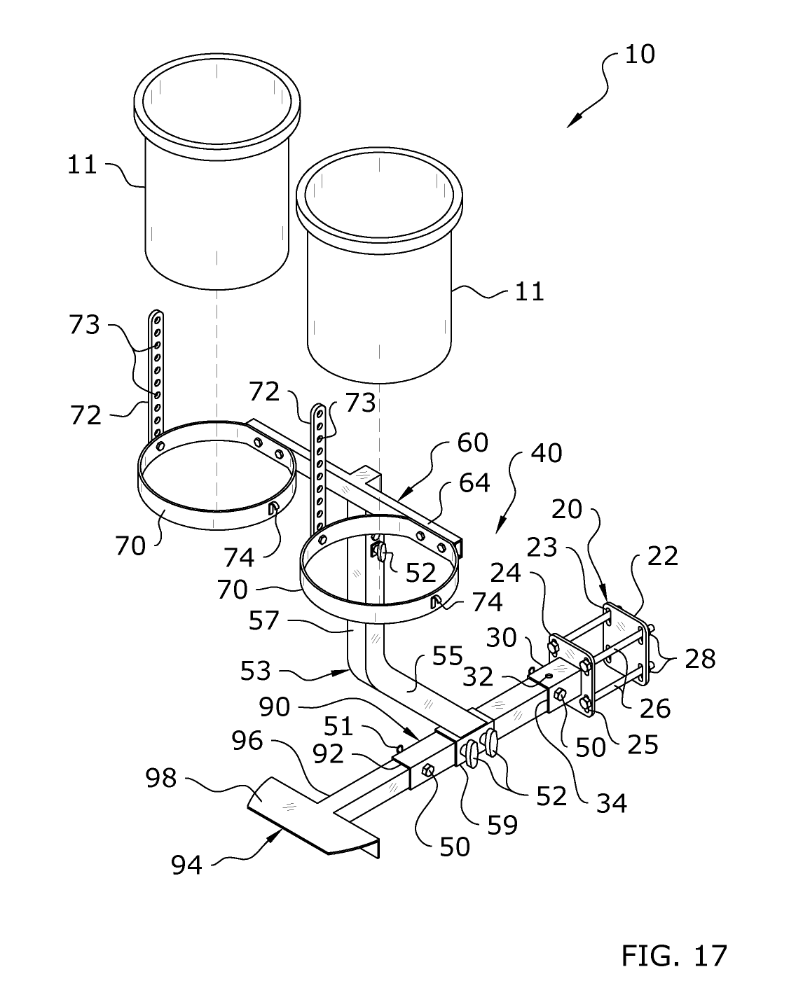

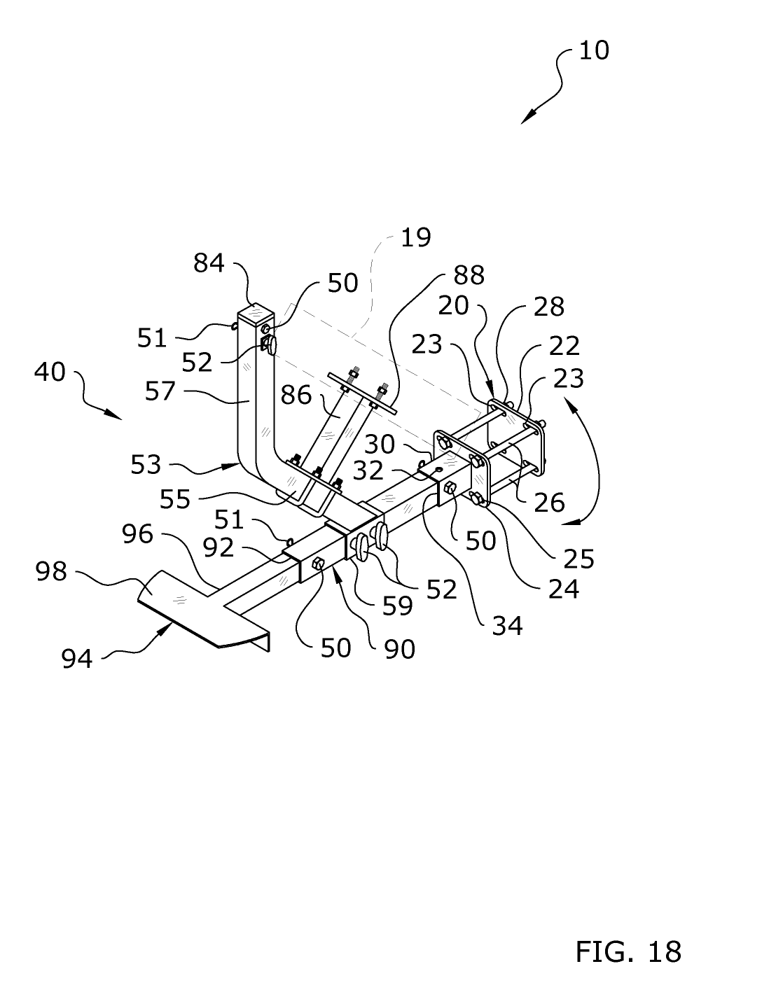

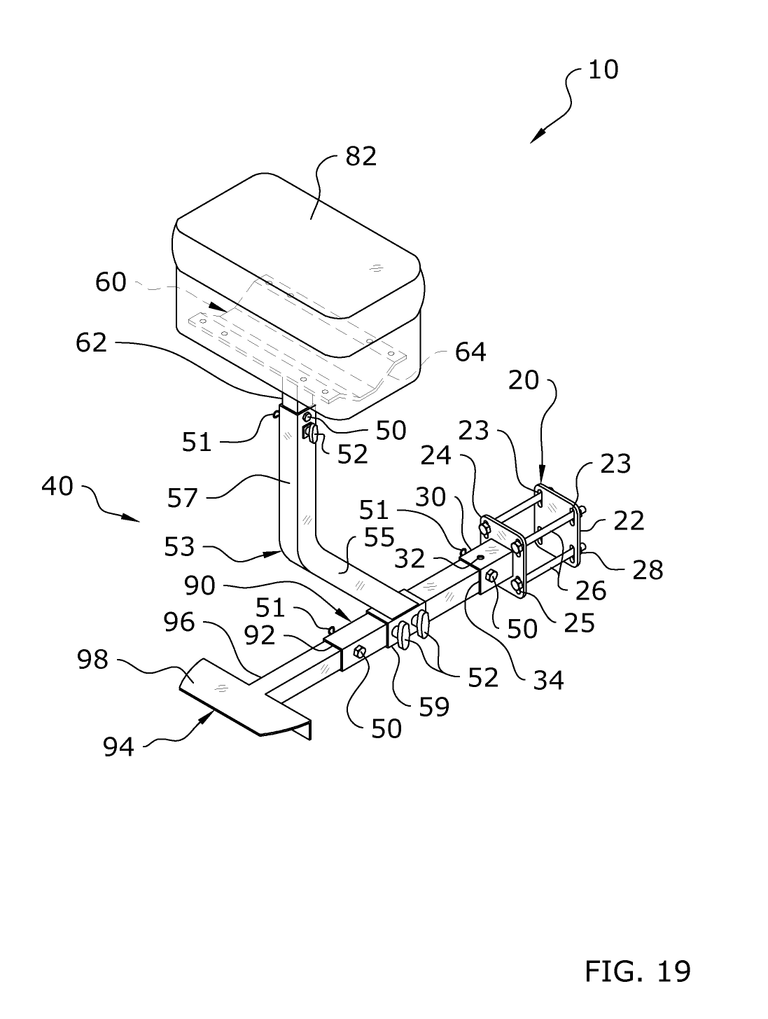

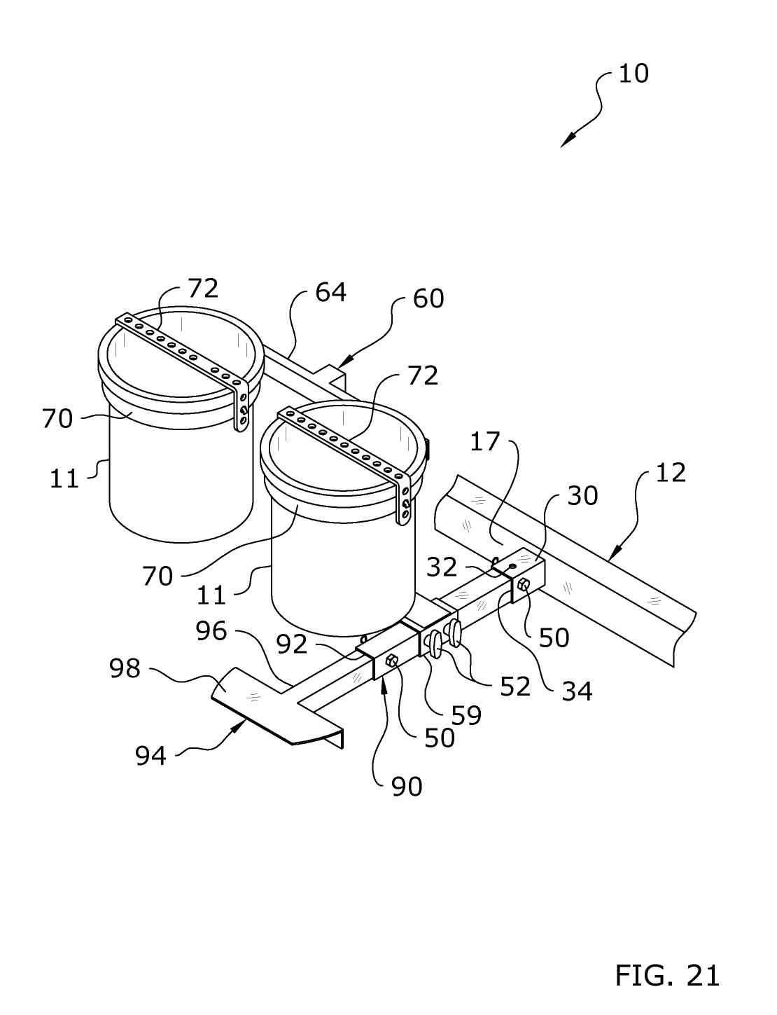

Turning now descriptively to the drawings, in which similar reference characters denote similar elements throughout the several views, FIGS. 1 through 22 illustrate an accessory exchange system for trailers 10, which comprises a mounting bracket 20 for mounting to the frame of a trailer 12, 18, a base coupler 30 extending from the mounting bracket 20, a support arm 40 removably connected to the base coupler 30, and an accessory device 70, 80, 82 removably connected to the support arm 40. The present invention is constructed of a rigid material such as but not limited to metal. A cap member 84 is removably attachable to the upper opening 48 of the support arm 40 or the vertical arm 53 when no accessory device 70, 80, 82 is attached.

### B. Trailer

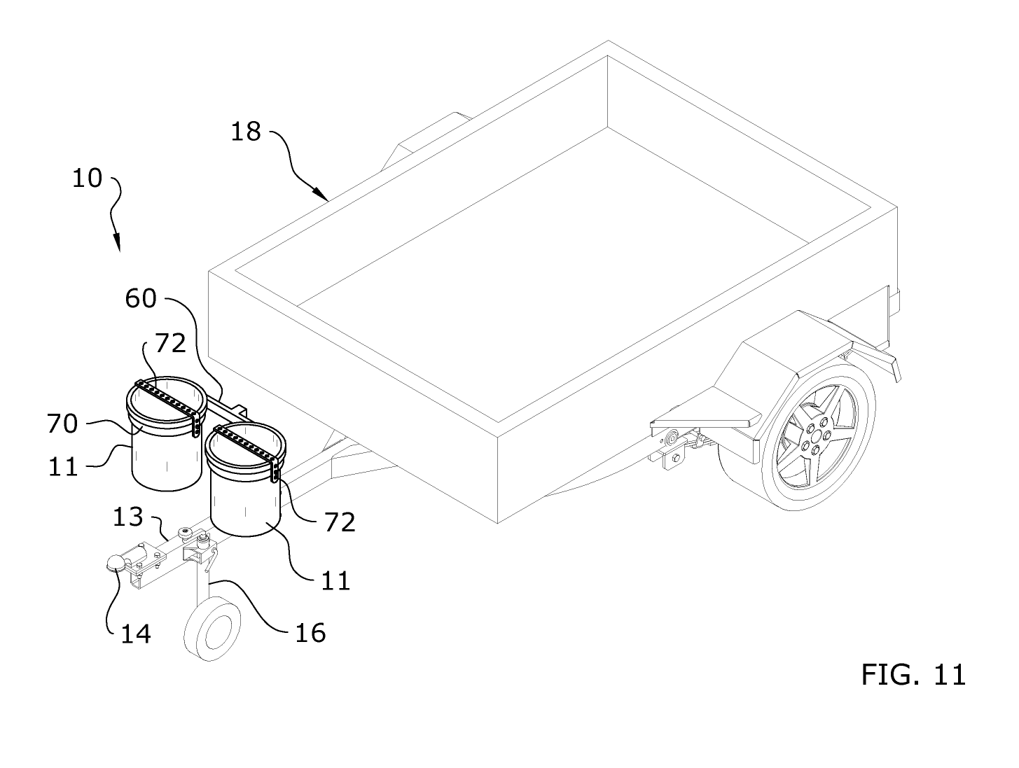

The trailer 12, 18 may be comprised of any type of conventional trailer 12, 18 such as but not limited to a boat trailer 12 (FIG. 1), utility trailer 18 (FIG. 11) or other type of trailer having a frame that the mounting bracket 20 is attachable to. The trailer 12, 18 includes a frame supported by two or more tires. The frame includes a pair of side frame members 17 and a trailer tongue 13 with a trailer coupler 14 which are well-known in the trailer industry. A jack 16 may be attached to the trailer tongue 13 to support the trailer tongue 13 upwardly when not in use. For a boat trailer 12, a winch 15 is typically attached to the trailer tongue 13. It can be appreciated that the trailer 12, 18 may be comprised of various different structures and configurations not shown in the drawings and may be comprised of any conventional trailer that is pulled behind a vehicle.

### C. Mounting Bracket

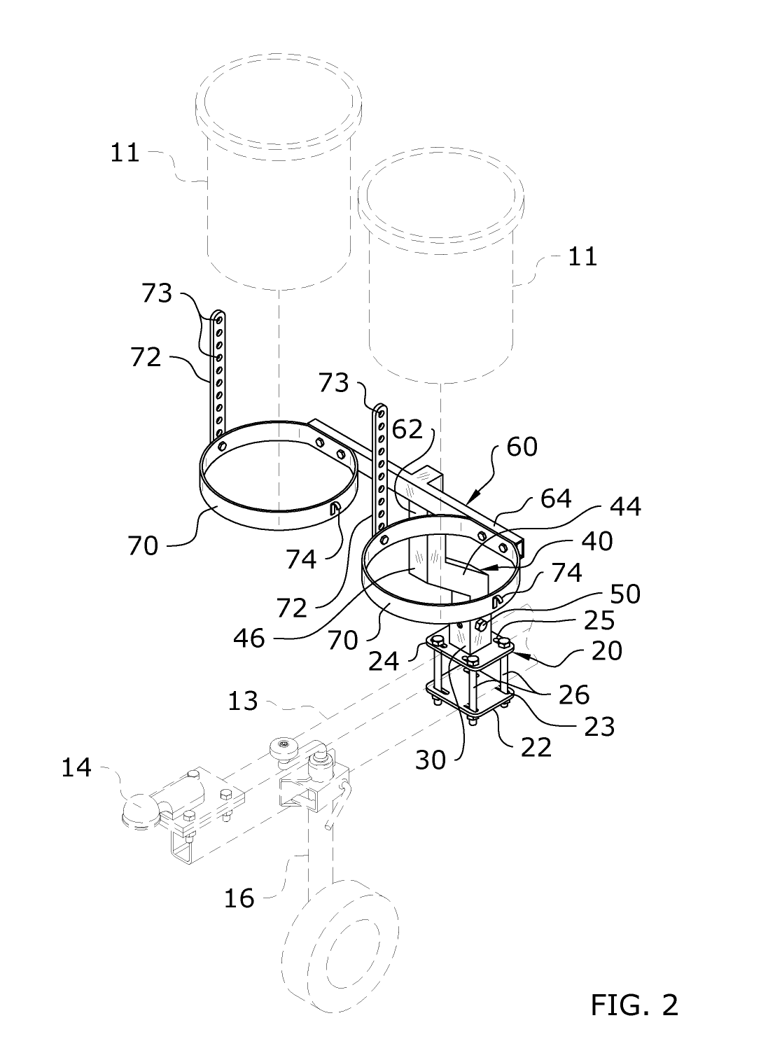

FIGS. 2, 3, 4, 9, 10, and 13 through 19 best illustrate the mounting bracket 20 that is adapted for mounting to a frame of a trailer 12, 18. The mounting bracket 20 may be adapted for mounting to the trailer tongue 13, side frame member 17 or other part of the trailer 12, 18. The mounting bracket 20 is further attachable to various types of trailers including boat trailers 12 and utility trailers 18.

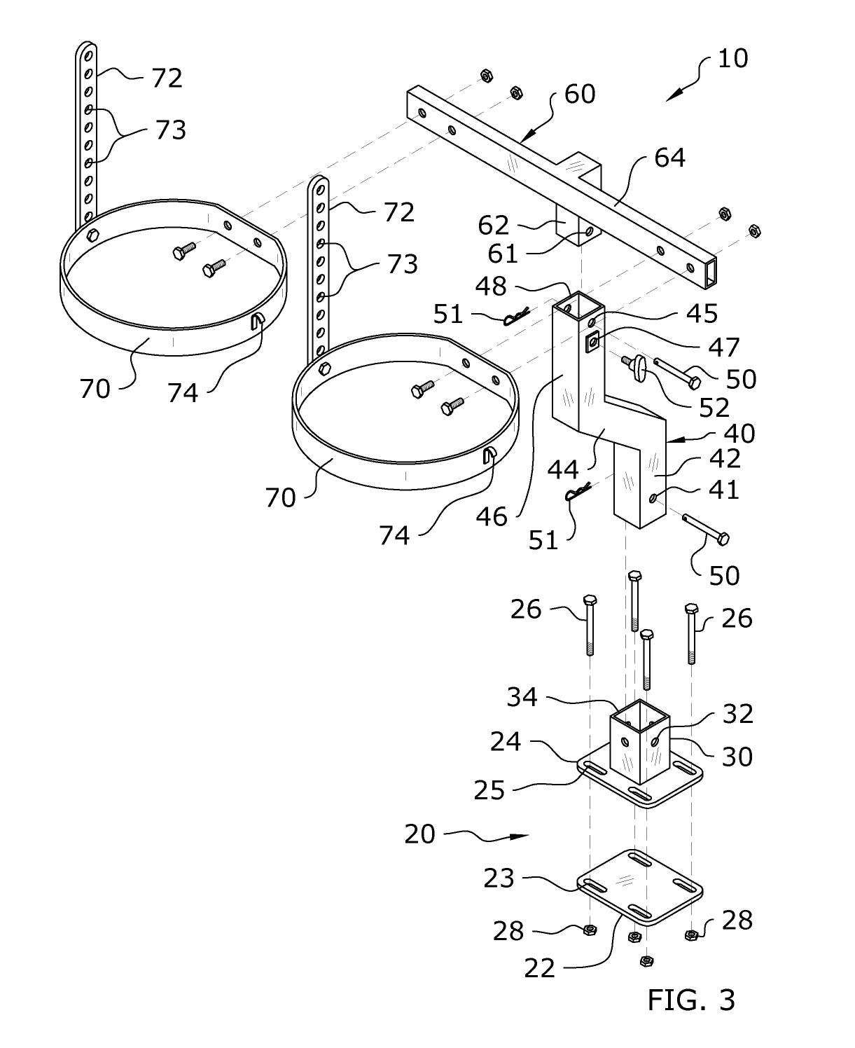

The mounting bracket 20 is preferably comprised of a first plate 22 and a second plate 24 as best illustrated in FIG. 3 of the drawings. The first plate 22 is positioned adjacent to a first surface of the trailer tongue 13 or side frame member 17 (e.g. bottom surface or inner side surface). The second plate 24 is positioned on the opposite side of where the first plate 22 is positioned. The first plate 22 is preferably parallel with respect to the second plate 24 when attached to the trailer 12, 18.

The first plate 22 includes a plurality of first apertures 23 and the second plate 24 includes a plurality of second apertures 25 that receive a corresponding plurality of mounting fasteners 26 that extend through the apertures and that are retained by mounting nuts 28 as illustrated in FIGS. 2 and 3 of the drawings. The user secures the mounting bracket 20 to the trailer tongue 13 or side frame member 17 of the trailer 12, 18 by tightening the mounting nuts 28 upon the mounting fasteners 26. The apertures within the first plate 22 and the second plate 24 are preferably comprised of slots that are aligned with one another to fit upon various sizes of trailer tongues 13 and side frame members 17. The slots are preferably aligned with the longitudinal axis for each of the plates 22, 24. The first plate 22 and the second plate 24 further are comprised of an elongated structure that may be rotated ninety degrees to accommodate different sizes of trailer tongues 13 or side frame members 17 to reduce movement thereupon.

### D. Base Coupler

As illustrated in FIGS. 2, 3, 4, 9, 10, and 13 through 19 of the drawings, a base coupler 30 extends from the mounting bracket 20. Alternatively, the base coupler 30 is permanently attached to the side frame member 17 of the trailer 12, 18 via welding or other permanent, non-removable connection.

The base coupler 30 preferably extends outwardly from the second plate 24 and extends outwardly away from the first plate 22. The base coupler 30 is adapted to removably connect with the support arm 40 as discussed herein.

The base coupler 30 is preferably comprised of a tubular structure with a receiver opening 34 within an outer end thereof as best illustrated in FIG. 3 of the drawings. The receiver opening 34 preferably has a square cross sectional area to receive a corresponding square shaped inner end of the support arm 40 wherein the outer end of the support arm 40 removably connects to the accessory device 70, 80, 82. The square shaped cross sectional area for the receiver opening 34 further allows for rotation of the support arm 40 into four different positions so that the accessory device 70, 80, 82 can avoid hitting various obstacles on the trailer 12, 18 (e.g. winch 15, jack 16, vehicle tailgate, etc.).

The base coupler 30 further includes one or more base apertures 32 that extend into the sidewalls of the base coupler 30. There are preferably four base apertures 32 that extend through the base coupler 30 with two pairs of the four base apertures 32 aligned with one another to receive a pin 50 so that a distal end of the pin 50 extends outwardly through the base coupler 30 (along with extending through an inner aperture 41 of the support arm 40) wherein a clip 51 may be attached to the pin 50 to prevent accidental removal thereof. Various other fastener systems may be utilized to removably retain the support arm 40 within the base coupler 30 (e.g. threaded fasteners).

### E. Support Arm—First Embodiment

FIGS. 2, 4, 7, 9, and 10 of the drawings best illustrate the first embodiment of the support arm 40 that is preferably removably connected to the base coupler 30. The support arm 40 may be permanently attached to the base coupler 30, however, it is preferable to have a removable attachment so a user may remove the support arm 40 when not in use. As best illustrated in FIG. 3 of the drawings, the support arm 40 is preferably comprised of a unitary elongated structure. The support arm 40 extends vertically to support the accessory device 70, 80, 82 a distance above the lower part of the frame of the trailer 12, 18.

As further shown in FIG. 3, the support arm 40 is preferably comprised of a lower portion 42, an upper portion 46 and an angled portion 44 between the lower portion 42 and the upper portion 46. The angled portion 44 extends upwardly at an angle away from the lower portion 42 as illustrated in FIG. 2 of the drawings. The angled portion 44 allows for connection of the mounting bracket 20 to a desired location on the trailer 12, 18 while allowing for adjustment of the vertical position of the accessory device 70, 80, 82 into a different position. Furthermore, the upper portion 46 and the lower portion 42 are preferably parallel and offset with respect to one another (i.e. are not concentric) and both extend upwardly along a vertical plane.

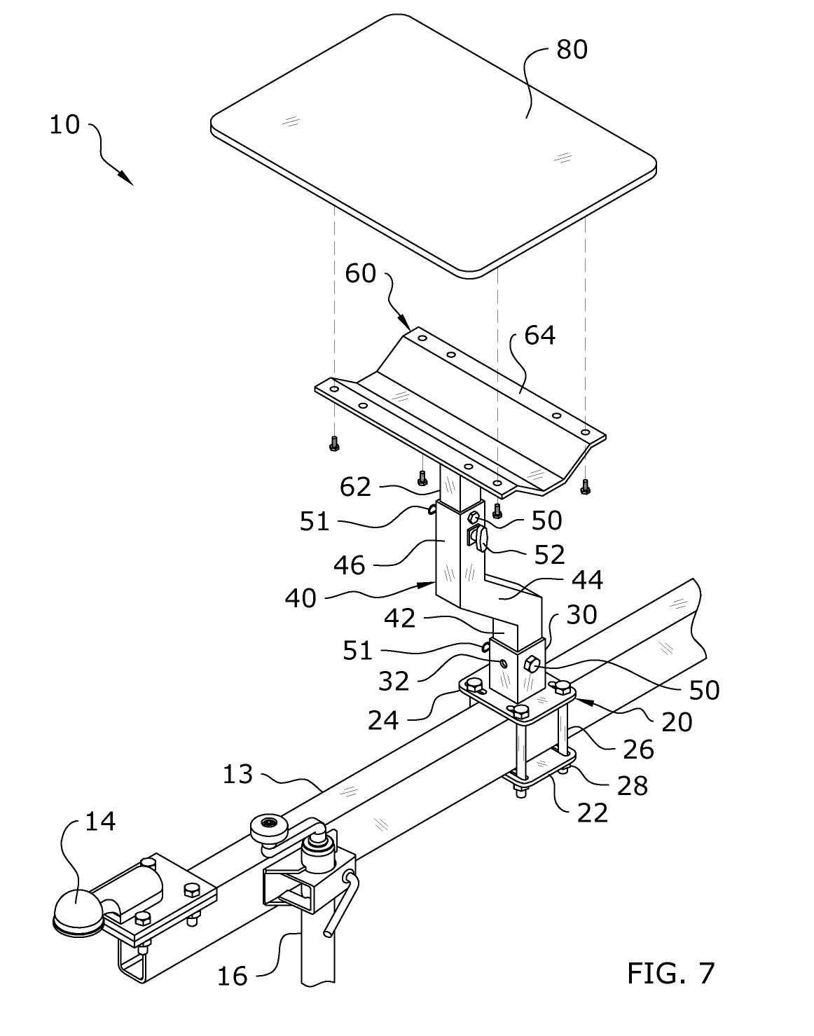

The support arm 40 includes a lower end that is received within a receiver opening 34 within the base coupler 30. The outer portion of the lower end is formed to have a shape and size that is snugly and slidably received within the interior of the receiver opening 34 of the base coupler 30 as illustrated in FIG. 7 of the drawings.

The upper portion 46 of the support arm 40 removably connects to the accessory device 70, 80, 82. The upper portion 46 of the support arm 40 preferably includes an upper opening 48 that receives a lower member 62 extending from the accessory device 70, 80, 82. The upper opening 48 within the support arm 40 preferably has a square cross sectional shape and the lower member 62 preferably has a corresponding square cross sectional shape to allow for rotating of the position of the accessory device 70, 80, 82 with respect to the support arm 40 in four different positions.

The upper portion 46 of the support arm 40 preferably includes an upper aperture 45 for receiving a pin 50 and/or a threaded aperture 47 that threadably receives an engaging member 52, wherein the engaging member 52 is comprised of a handle and a threaded shaft that extends outwardly from the handle. The threaded shaft is threadably engaged within the interior of the threaded aperture 47 within the support arm 40 thereby allowing the user to frictionally engage the lower member 62 of the accessory device 70, 80, 82 or extend through an accessory aperture 61 within the lower member 62 as illustrated in FIG. 3 of the drawings. It is preferable that there are a plurality of upper apertures 45 and/or threaded apertures 47 within the upper portion 46 of the support arm 40 to allow for selective engagement of the lower member 62 in at least four different rotational positions.

### F. Support Arm—Second Embodiment

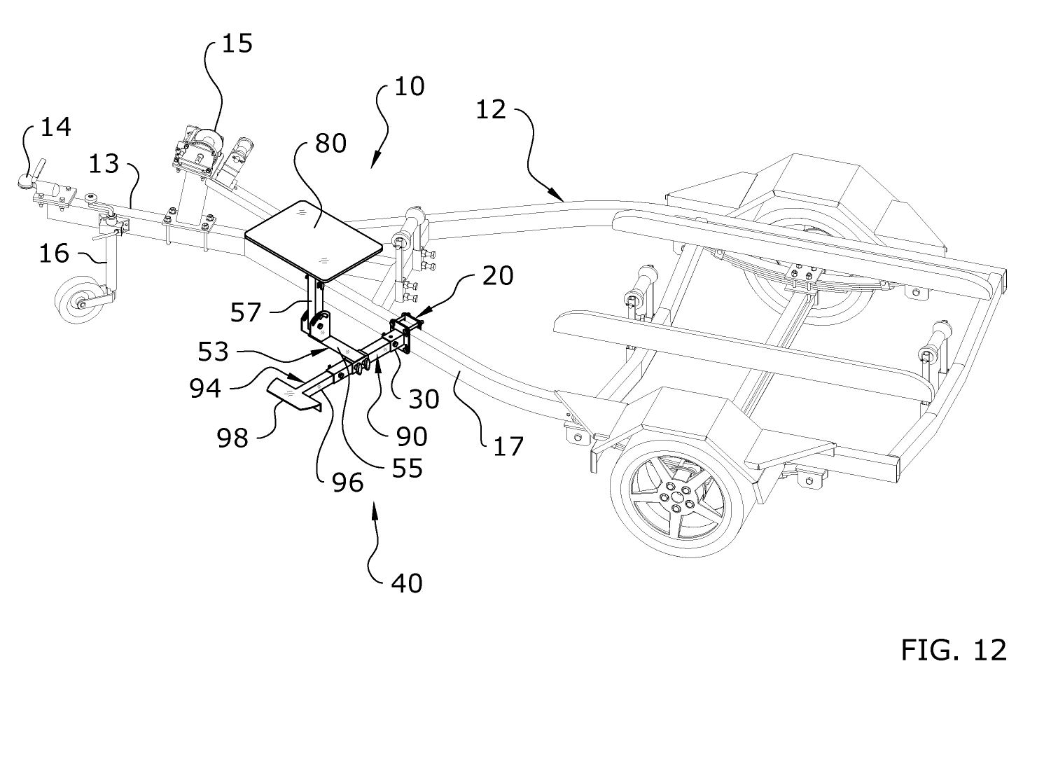

FIGS. 12, 13, 14, and 16 through 19 of the drawings best illustrate the second embodiment of the support arm 40 which includes an extended arm 90 that extends substantially horizontally away from the side frame member 17 of the trailer 12, 18 and a vertical arm 53 extending upwardly away from the extended arm 90. The extended arm 90 extends outwardly away from the trailer 12, 18. The accessory device 70, 80, 82 is removably connected to an upper end of the vertical arm 53. The vertical arm 53 may be permanently attached to the extended arm 90 or adjustably attached to the extended arm 90. The upper end of the vertical arm 53 includes the upper opening 48 to removably receive the lower member 62 of the accessory bracket 60 as in the first embodiment. The upper end of the vertical arm 53 further preferably includes an upper aperture 45 and/or threaded aperture 47 for receiving a pin 50 or engaging member 52 respectively to selectively secure the lower member 62 to the vertical arm 53 similar to the first embodiment.

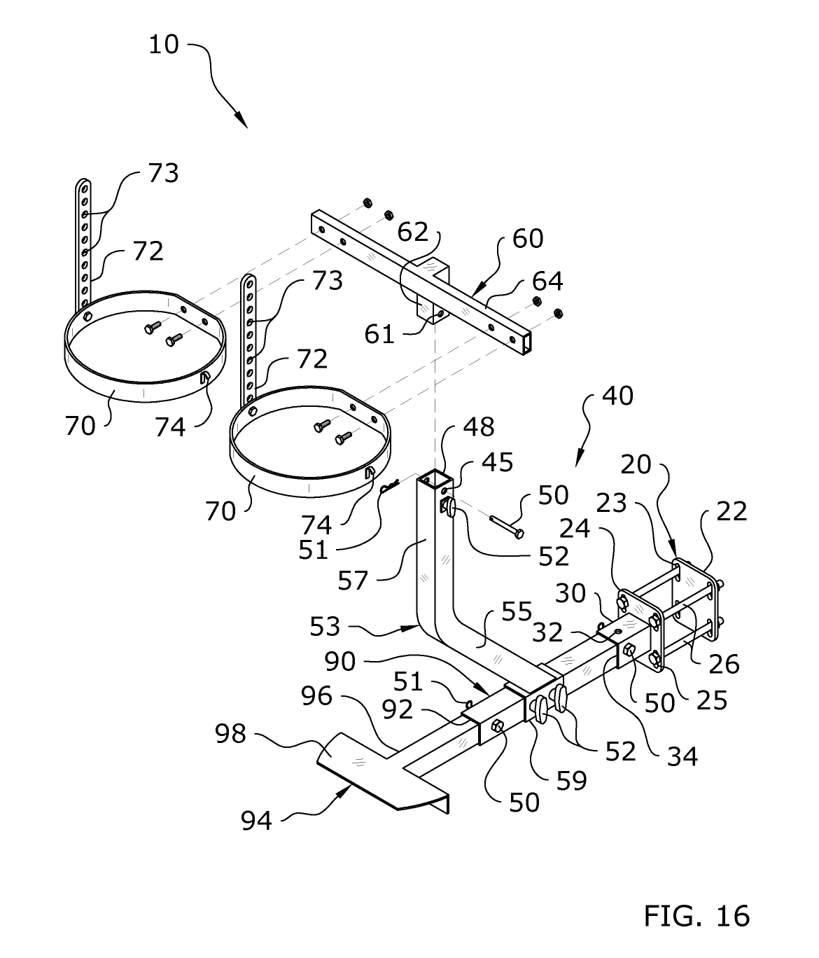

FIG. 16 illustrates a tubular coupler 59 that is slidably positioned upon the extended arm 90 and which the support arm 40 extends upwardly from. The tubular coupler 59 includes one or more engaging members 52 that threadably extend through the tubular coupler 59 to frictionally engage the engaging member 52 thereby allowing for selective positioning of the tubular coupler 59 along the extended arm 90 to accommodate various configurations for trailers.

The vertical arm 53 may be comprised of a unitary structure as illustrated in FIGS. 16. As further shown in FIG. 16, the vertical arm 53 includes a first portion 55 connected to the extended member that extends upwardly at an angle and a second portion 57 that extends vertically.

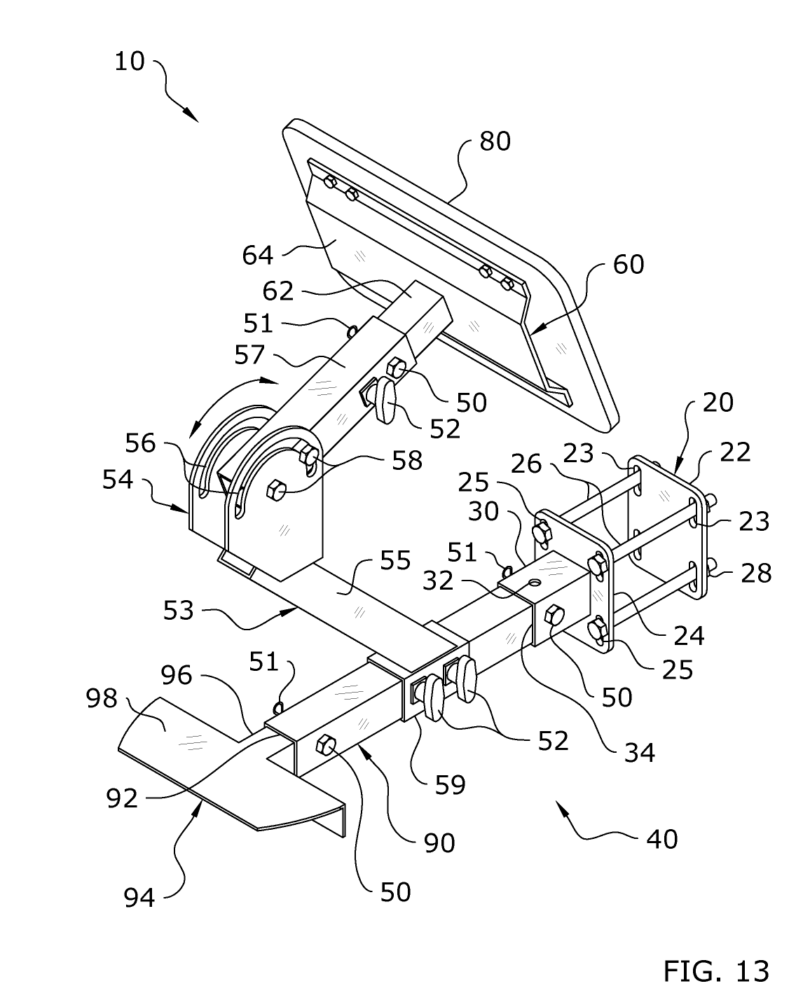

The vertical arm 53 may be adjustably positioned upon the extended arm 90 to allow for adjusting the position of the accessory device 70, 80, 82 with respect to the trailer 12, 18 without having to adjust the mounting bracket 20. The vertical arm 53 may also be comprised of an adjustable 80 and foldable structure to allow for allowing selective positioning of the accessory device 70, 80, 82 into a storage position (FIG. 13) close to the trailer 12, 18 or an extended position (FIG. 12) for usage.

In the folding embodiment, the vertical arm 53 includes a first portion 55, a pivot joint 54 connected to the first portion 55 and a second portion 57 connected to the pivot joint 54 opposite of the first portion 55. An angle between the first portion 55 and the second portion 57 is adjustable 80 by the pivot joint 54 wherein the user is able to adjust the position of the second portion 57 with respect to the first portion 55 by adjusting the pivot joint 54. The pivot joint 54 includes one or more sidewalls that pivotally receive the second portion 57, wherein the sidewalls each include a curved slot 56 that receives a securing fastener 58 that extends through the curved slots 56 within the sidewalls and through an aperture within the second portion 57 to allow for selective securing by tightening of the securing fastener 58 when the second portion 57 is pivoted to the desired position (e.g. extended position, storage position).

It is preferable that a step unit 94 is attached to a distal portion of the extended arm 90 as illustrated in FIGS. 12 through 19 of the drawings. The step unit 94 allows a user to step upon with their foot to view the interior of the trailer 12, 18 or the interior of the boat positioned upon the boat trailer 12. The step unit 94 is comprised of a step tongue 96 removably received within the an outer opening 92 within the extended arm 90 and a step member 98 attached to the step tongue 96. The step tongue 96 is removably secured within the outer opening 92 within the extended arm 90 by a pin 50 with a clip 51 or other fastener device. The step unit 94 may be removed when not in use or remain attached to the extended member. The step unit 94 may also be permanently attached to the extended member.

### G. Accessory Device

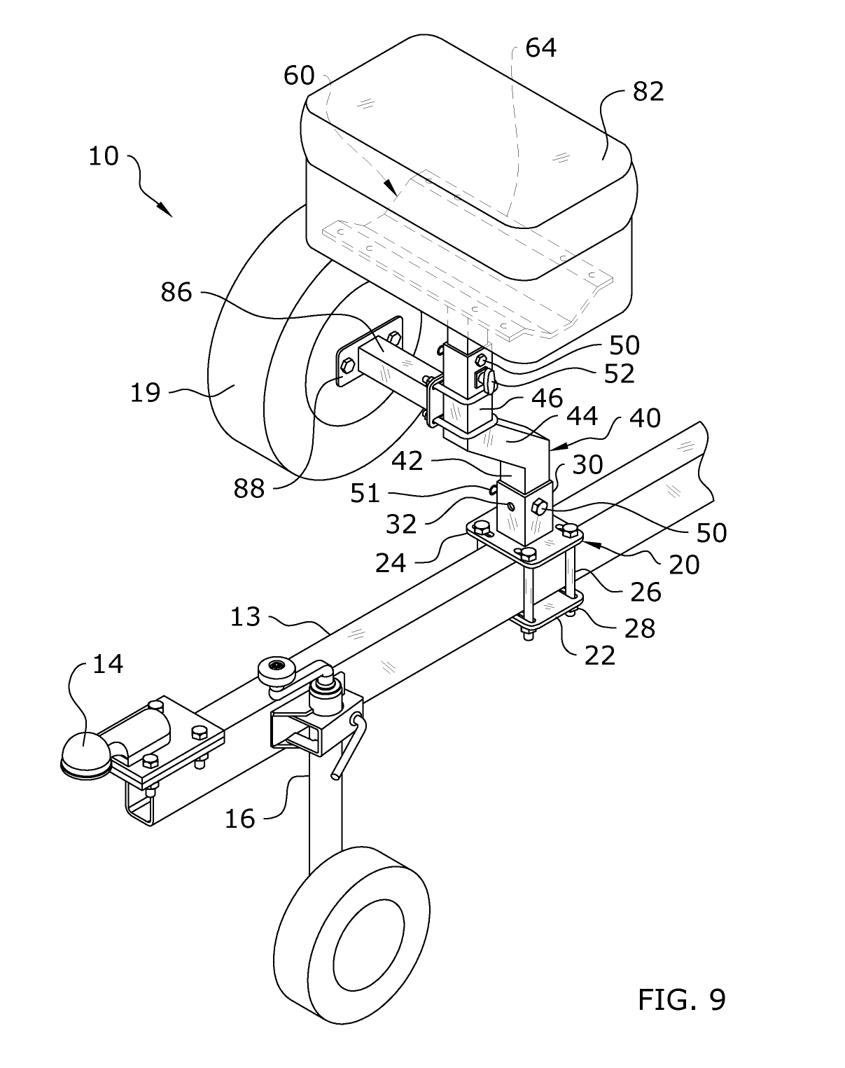

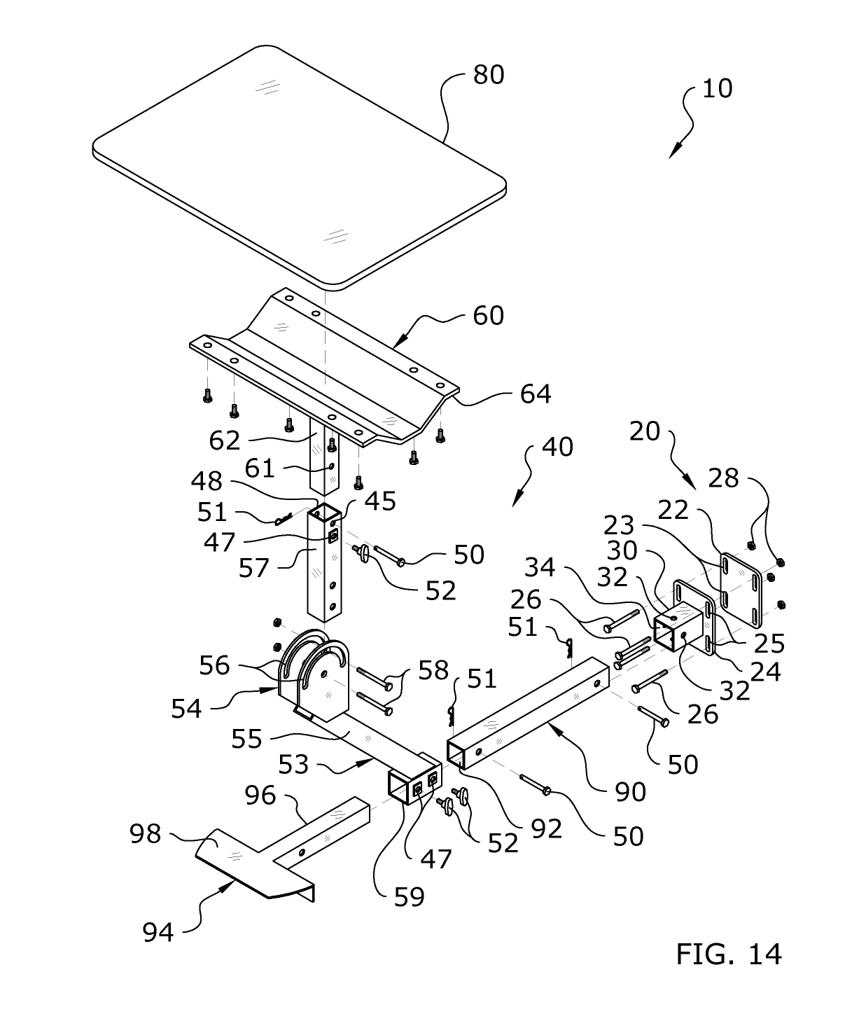

The accessory device 70, 80, 82 is removably connected to the support arm 40 to allow for changing of the accessory device 70, 80, 82 attached to the trailer 12, 18 as illustrated in FIGS. 3 and 14 of the drawings. The accessory device 70, 80, 82 may be comprised of any type of accessory suitable 80 for attachment to a trailer 12, 18 such as but not limited to a bucket holder (FIGS. 1-2), a table 80 (FIG. 7) or a storage unit 82 (FIG. 9).

The accessory device 70, 80, 82 preferably includes an accessory bracket 60 attached to a lower part of the accessory device 70, 80, 82, wherein the accessory bracket 60 is removably connected to the support arm 40. The accessory bracket 60 is preferably comprised of a support member 64 attached to the accessory device 70, 80, 82 and a lower member 62 extending downwardly from the support member 64, wherein the lower member 62 is removably connected to the support arm 40. The lower member 62 is preferably slidably positioned with respect to the support arm 40. The lower member 62 is received within an upper opening 48 within the support arm 40 as illustrated in FIG. 3 of the drawings. The accessory bracket 60 forms a T-shaped structure as illustrated in FIGS. 3 and 7 of the drawings. A fastener or other device secures the lower member 62 within the upper opening 48 of the support arm 40. The upper opening 48 of the support arm 40 preferably faces upwardly.

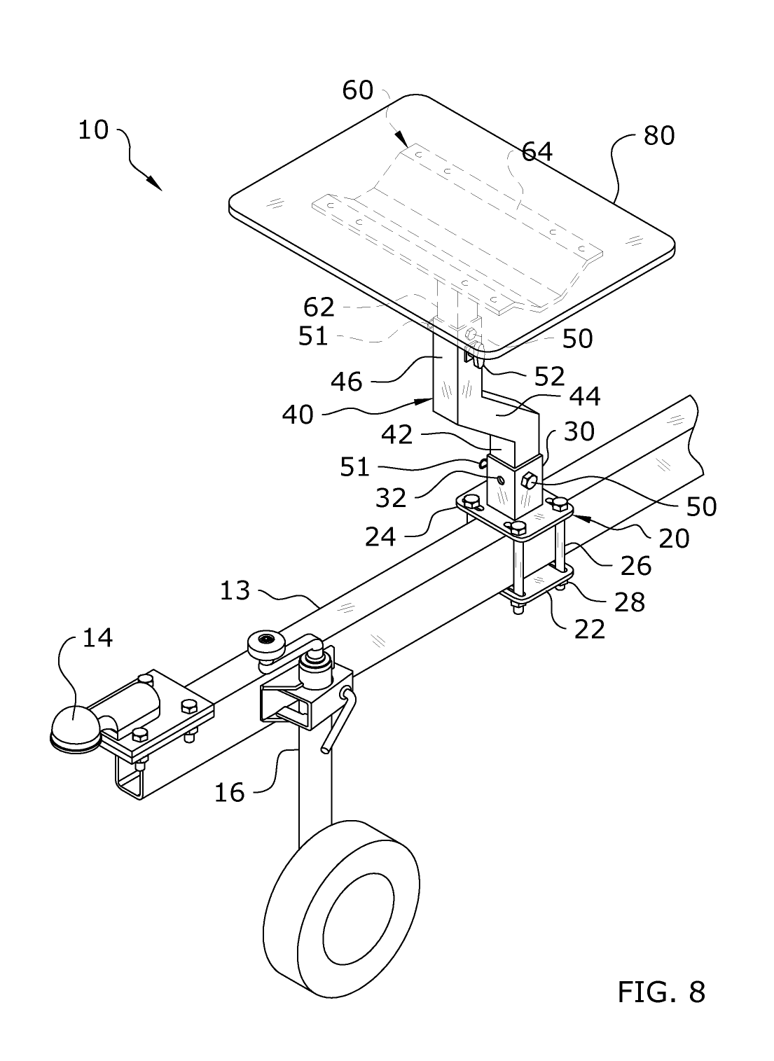

The table 80 may be comprised of various types of materials and have various different shapes known to tables 80. It is particularly preferable that the table 80 is comprised of a fish fillet table 80 for allowing a fisherman to fillet fish upon. The table 80 is preferably comprised of a rigid, flat and thin plastic material as illustrated in FIGS. 7 and 8 of the drawings. A plurality of fasteners secure the table 80 to the support member 64 of the accessory bracket 60 along with an alignment member that extends upwardly from the support member 64 into an aperture within the bottom surface of the table 80.

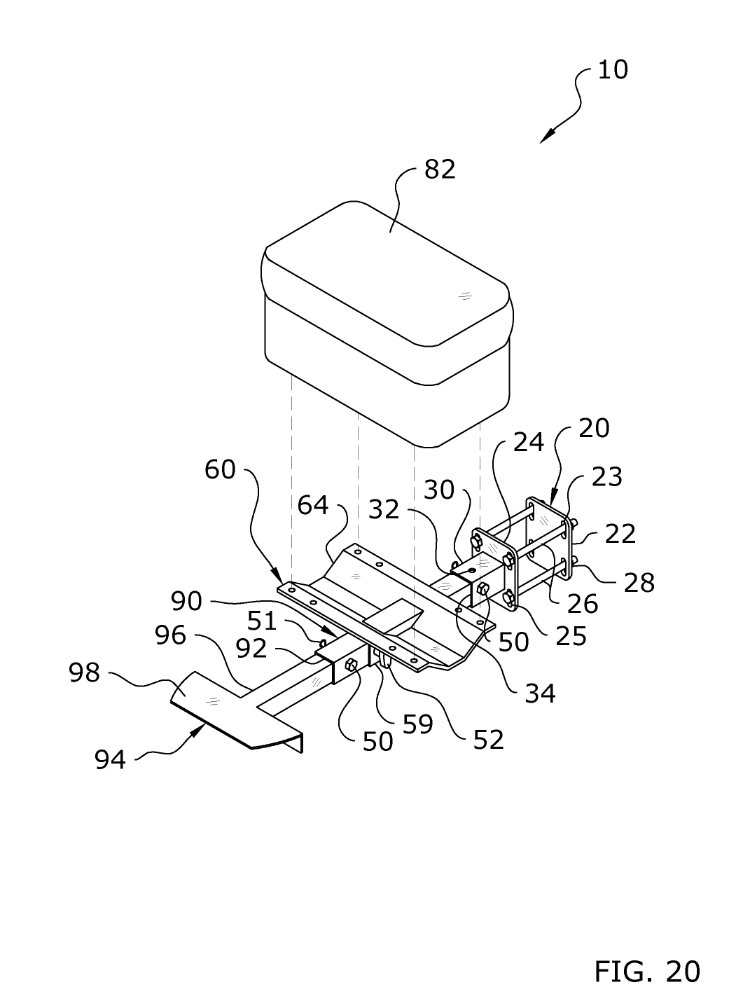

The storage unit 82 may be comprised of any structure capable of storing items and that preferably has a cover as illustrated in FIG. 9 of the drawings. The storage unit 82 is attached to the support member 64 with one or more fasteners. Alternatively, the storage unit 82 may be connected to the tubular coupler 59 or directly to the extended arm 90 as illustrated in FIG. 20 of the drawings.

The bucket holder is adapted to support one or more buckets 11 as illustrated in FIGS. 2 through 3 of the drawings. The bucket holder includes one or more support rings 70 that extend horizontally outwardly from the support member 64 of the accessory bracket 60. The support rings 70 have an interior diameter slightly larger than the main portion of the buckets 11 but smaller than the upper rim of the buckets 11 to prevent the buckets 11 from falling through the interior opening of the support rings 70. Each support ring 70 preferably includes an elastic securing strap 72 is attached to one side of the support ring 70 and includes a plurality of securing apertures 73 that catchably receive a securing member 74 extending from an opposite side of the support ring 70. The securing member 74 is preferably comprised of a downwardly facing hook member as best illustrated in FIG. 3 of the drawings. The support rings 70 may be attached to the support member 64 with a plurality of fasteners.

### H. Tire Holder

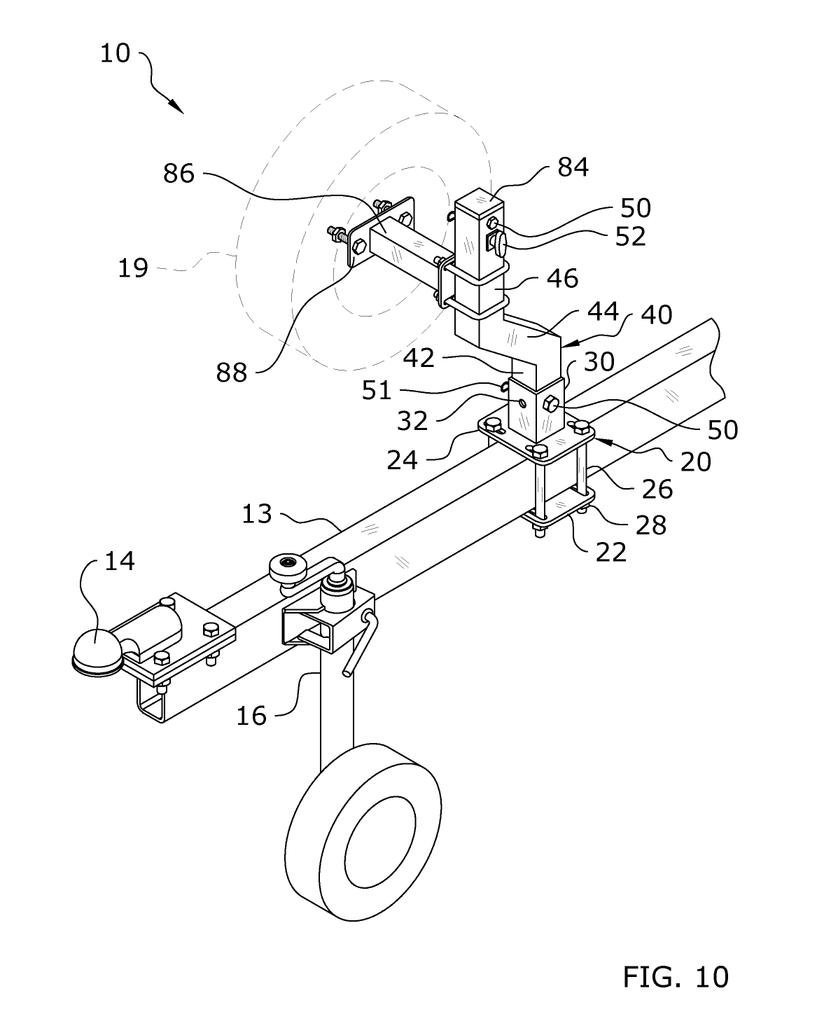

FIGS. 9 and 10 illustrate a tire holder that is attached to the support arm 40 and extends outwardly to support a vehicle tire 19 on the distal end thereof. The tire holder is comprised of a tire support 86 that extends outwardly from the support arm 40 and a tire bracket 87 that includes one or more threaded fasteners that extend through apertures within the rim of the tire to which a corresponding number of threaded nuts are attached to for retaining the vehicle tire 19 upon the tire holder. The tire holder preferably extends outwardly from the side of the support arm 40 so as to not interfere with the accessory device 70, 80, 82 attached to the support arm 40.

### I. Seat

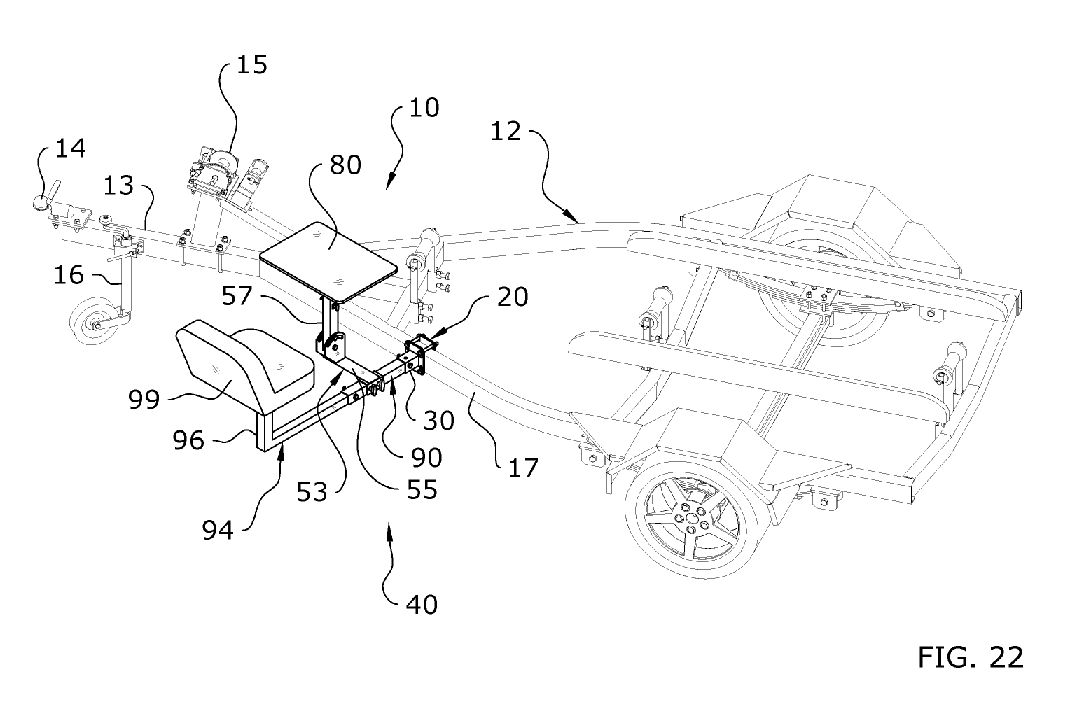

FIG. 22 illustrates a tongue 94 removably connected to the extended arm 90, wherein the tongue 94 extends outwardly horizontally and then extends upwardly vertically. The upper end of the tongue 94 on the vertical portion includes an aperture that receives a seat 99. The user is able to sit upon the seat 99 while using the table 80.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

1. An accessory exchange system for trailers, comprising:
a mounting bracket adapted for mounting to a frame of a trailer, said mounting bracket including a first plate and a second plate;
a base coupler extending from said mounting bracket;
a support arm connected to said base coupler; and
an accessory device removably connected to said support arm.

2. The accessory exchange system of claim 1, wherein said mounting bracket is adapted for mounting to a trailer tongue or a side frame member of said trailer.

3. (canceled)

4. The accessory exchange system of claim 1, wherein said accessory device is comprised of a bucket holder, a table or a storage unit.

5. The accessory exchange system of claim 1, wherein said accessory device includes an accessory bracket attached to said accessory device and removably connected to said support arm.

6. The accessory exchange system of claim 5, wherein said accessory bracket is comprised of a support member attached to said accessory device and a lower member adjoined below said support member, wherein said lower member is removably connected to said support arm.

7. The accessory exchange system of claim 6, wherein said lower member is slidably positioned with respect to said support arm.

8. The accessory exchange system of claim 6, wherein said lower member is at least partially one of enveloped or enclosed to said support arm.

9. The accessory exchange system of claim 6, wherein said accessory bracket forms a T-shaped structure.

10. The accessory exchange system of claim 6, wherein said support arm includes an aperture within an upper portion of said support arm that receives a securing member to removably secure said lower member to said support arm.

11. The accessory exchange system of claim 10, wherein said aperture is comprised of a threaded aperture and wherein said securing member is comprised of an engaging member, wherein said engaging member is comprised of a handle and a threaded member that is threadably received within said threaded aperture.

12. The accessory exchange system of claim 1, wherein said support arm is comprised of a lower portion, an upper portion and an angled portion between said lower portion and said upper portion.

13. (canceled)

14. (canceled)

15. The accessory exchange system of claim 1, wherein said base coupler extends outwardly from said first and second plates.

16. The accessory exchange system of claim 1, wherein said support arm is comprised of an extended arm that extends outwardly away from said trailer and a vertical arm that extends upwardly from said extended arm, wherein said accessory device is removably connected to an upper end of said vertical arm.

17. The accessory exchange system of claim 16, wherein said vertical arm includes a first portion, a pivot joint connected to said first portion and a second portion connected to said pivot joint opposite of said first portion, wherein an angle between said first portion and said second portion is adjustable by said pivot joint.

18. The accessory exchange system of claim 16, including a step unit attached to a distal portion of said extended arm.

19. The accessory exchange system of claim 18, wherein said step unit is comprised of a step tongue and a step member attached to said step tongue, wherein said step tongue is removably received within said an outer opening within said extended arm.

20. The accessory exchange system of claim 16, wherein said vertical arm is slidably positioned upon said extended arm.

21. The accessory exchange system of claim 16, wherein said vertical arm is secured upon said extended arm through a tubular coupler and engaging members.

22. An accessory exchange system for trailers, comprising:
a mounting bracket adapted for mounting to a frame of a trailer;
a base coupler extending from said mounting bracket;
a support arm connected to said base coupler, said support arm including a lower end that is received within a receiver opening within said base coupler; and
an accessory device removably connected to said support arm, and wherein said base coupler includes a tubular structure and wherein said receiver opening is within an outer end thereof, and includes a square cross sectional area to receive a corresponding square shaped inner end of the support arm.

23. An accessory exchange system for trailers, comprising:
a mounting bracket adapted to secure said accessory exchange system to a frame of a trailer;
a base coupler extending from said mounting bracket;
a support arm connected to said base coupler; and
an accessory device removably connected to said support arm.
